(19) United States
(12) Patent Application Publication
(10) Pub. No.: US 2011/0258372 A1
(43) Pub. Date: Oct. 20, 2011

(54) MEMORY DEVICE, HOST DEVICE, AND MEMORY SYSTEM

(75) Inventors: Masayuki Toyama, Osaka (JP); Hirokazu So, Kyoto (JP)

(73) Assignee: PANASONIC CORPORATION, Osaka (JP)

(21) Appl. No.: 13/140,887

(22) PCT Filed: Jul. 27, 2010
(86) PCT No.: PCT/JP2010/004758

§ 371 Date: Jun. 20, 2011

(30) Foreign Application Priority Data
Jul. 29, 2009 (JP) 2009-176884

(51) Int. Cl. G06F 12/00

(52) U.S. Cl. 711/103; 711/E12.008

(57) ABSTRACT

A memory device, a host device, and a memory system enable real-time recording of a plurality of files of data while preventing the buffer size of a host device from increasing. A memory device (1) has first and second data write modes. A host device (2) uses the second data write mode when recording a plurality of files of data. In accordance with a command provided from the host device (2), the memory device (1) relocates data that has been written in the second data write mode in a manner that the data is arranged in the same state as when the data is written in the first data write mode.

### TECHNICAL FIELD

The present invention relates to a memory device that includes a nonvolatile memory and writes and reads data to and from the nonvolatile memory in accordance with a command provided from a host device, a host device that is connected to the memory device and writes and reads data to and from the nonvolatile memory, and a memory system including the host device and the memory device.

### BACKGROUND ART

Devices that control digital information, such as digital cameras, movie cameras, and mobile telephones (hereafter referred to as “host devices”), increasingly use nonvolatile memories as their storage units for storing digital information. A NAND flash memory is an example of such nonvolatile memories. The recent trend toward miniaturization requires nonvolatile memories to change their specifications frequently. To handle such changes, many host devices now use a memory device that is formed by a nonvolatile memory and a memory controller unit. Examples of such memory devices include a removable card, which is removable from a host device, and an embedded device, which is directly mounted on the substrate of a host device.

Also, the recent increase in the capacity of a nonvolatile memory built in a memory device has broadened the usage of the memory device to record moving images. When recording moving image data, the memory device is required to perform real-time recording, which is the writing of data in real time by guaranteeing a predetermined writing speed. Patent Literature 1 describes a technique for performing real-time recording onto a memory device that uses a nonvolatile memory.

Patent Literature 1 describes a technique for enabling real-time recording to be performed under a predetermined condition. In a nonvolatile memory system (a nonvolatile system including a host device and a memory device) using the technique described in Patent Literature 1, the storage area of a nonvolatile memory included in the memory device is managed in predetermined allocation units (Ails), and the recording performance of the memory device is defined as its performance measured when a predetermined size of data is recorded continuously in each allocation unit. In the nonvolatile memory system, the memory device transmits information about its recording performance to the host device, and the host device then performs the processing for writing data to the memory device in a manner to satisfy the recording performance of the memory device. This enables real-time recording to be performed under a predetermined condition (under a condition satisfying the recording performance of the memory device). More specifically, the technique described in Patent Literature 1 uses, as a reference performance for guaranteeing a minimum speed of data writing, the performance measured when a predetermined size of data is continuously recorded in each allocation unit of the nonvolatile memory of the memory device, and enables real-time recording to be performed at the guaranteed minimum writing speed.

In actual real-time recording, normal data and file system information are recorded alternately. To enable real-time recording, the technique described in Patent Literature 1 defines the recording performance of the memory device separately for normal data and for file system information to prevent the recording performance of file system information from affecting the recording performance of normal data.

As described above, the conventional technique defines the recording performance of the memory device based on the recording performance measured when data is continuously written to each allocation unit (AU). In this case, the recording performance of the memory device fails to consider its instantaneous changes (for example, changes in the data writing speed) that may occur when data is written within the range of a single allocation unit. More specifically, the conventional technique allows any changes in the data writing speed to occur when data is written within the range of a single allocation unit as long as the recording performance can be guaranteed at the timing when data having the size of an allocation unit has been written completely. In other words, the conventional technique guarantees the recording performance only when data having the size of an allocation unit has been written to the nonvolatile memory of the memory device.

In this nonvolatile memory system, the host device is required to include a buffer having the size of an allocation unit to deal with instantaneous changes occurring in the recording performance (for example, changes in the data writing speed).

The host device writes normal data and file system information to the memory device via the same interface. In this case, while file system information is being written to the memory device, normal data writing to the memory device cannot be performed and needs to wait. In this nonvolatile memory system, the host device is further required to include a buffer for storing the normal data while the file system information is being written.

### CITATION LIST

### Patent Literature

Patent Literature 1: Japanese Unexamined Patent Publication No. 2006-178923

### SUMMARY

### Technical Problem

Television sets or digital video recorders (DVRs) developed recently are capable of recording moving images onto a memory device that uses a nonvolatile memory. Among such devices, devices having a plurality of tuners may record, as a plurality of files, a plurality of pieces of moving image data corresponding to a plurality of channels onto a memory device. In that case, the plurality of data files are normally recorded in different allocation units in the memory device. However, the conventional technique guarantees the recording performance only when data having the size of an allocation unit has been written to an allocation unit. To record a plurality of data files onto different allocation units in real time, the conventional technique requires the host device to include a buffer having the size of an allocation unit for each of the plurality of files.

Further, when the number of files to be recorded onto the memory device increases, the file system information needs to be updated the same number of times as the increasing number of files. While file system information is being written, normal data writing cannot be performed and needs to wait. When the number of files to be recorded increases and the number of times the file system information is to be written increases accordingly, the host device will be accordingly required to have a larger buffer size.

More specifically, the conventional technique, which is not intended for recording of a plurality of pieces of moving image data in real time, increases the required buffer size of the host device in proportion to the number of channels of data to be recorded.

To solve the above problem, it is an object of the present invention to provide a memory device, a host device, and a memory system that enable real-time recording of a plurality of pieces of moving image data while preventing the buffer size of a host device from increasing.

### Solution to Problem

A first aspect of the present invention provides a memory device that is connected to a host device to allow communication with the host device, and writes data and/or reads data in accordance with a command provided from the host device. The memory device includes a nonvolatile memory and a memory controller unit.

The nonvolatile memory stores data. The memory controller unit controls writing of data to the nonvolatile memory and reading of data from the nonvolatile memory using a logical address included in the command provided from the host device, manages a memory area of the nonvolatile memory in memory allocation units, and controls data and file system information corresponding to the data to be written into different memory allocation units.

The memory controller unit sets a data write mode by switching to a first data write mode or to a second data write mode as designated by the host device and controls writing of data to the nonvolatile memory to be performed in the set data write mode. The memory controller unit performs processes (1) and (2) below.

(1) When writing data in the first data write mode, the memory controller unit associates a logical address of the host device with a physical address of the nonvolatile memory for each memory allocation unit, and selects a memory allocation unit into which the data is to be written in a physical address space of the nonvolatile memory using a logical address included in a data write command provided from the host device in a manner that a data arrangement in the memory allocation unit in a logical address space managed by the host device is identical to a data arrangement in the memory allocation unit in the physical address space of the nonvolatile memory, and writes the data into the selected memory allocation unit.

(2) When writing data in the second data write mode, the memory controller unit selects a memory allocation unit into which the data is to be written in the physical address space of the nonvolatile memory as a memory allocation unit for the second data write mode, and continuously writes write-target data received from the host device in the selected memory allocation unit for the second data write mode irrespective of a logical address included in a data write command provided from the host device.

When, for example, the memory device records a plurality of files of data arranged in different MAUs (memory allocation units) in the logical address space, the memory device performs the data writing in the second data write mode. The use of the second data write mode enables the write data with discontinuous logical addresses to be written continuously in the memory area of the nonvolatile memory. The memory device writes data efficiently in a short time. As a result, the host device connected to this memory device is required to include a buffer with a small size. The use of this memory device together with the host device enables, for example, real-time recording of a plurality of pieces of moving image data (data writing guaranteeing a minimum write speed) to be performed while preventing the buffer size of the host device from increasing.

The nonvolatile memory may be one of a plurality of nonvolatile memories included in the memory device.

Writing continuously refers to, for example, continuously receiving data that is transmitted continuously from the host device and writing the received data continuously to the nonvolatile memory in the order in which the data has been received.

The memory allocation unit is a unit for managing the memory area of the nonvolatile memory by dividing the memory area, and preferably has the size of an N-th multiple of a physical management unit of the memory area (N is a natural number). The physical management unit may be, for example, a physical block that is a unit of erasure used by a NAND flash memory.

A second aspect of the present invention provides the memory device of the first aspect of the present invention in which the memory controller unit writes data in the first data write mode in an initial state when the memory device is powered on or reset, and switches the data write mode to the second data write mode in accordance with a data write mode designating command provided from the host device.

A third aspect of the present invention provides the memory device of the first aspect of the present invention in which the memory controller unit switches the data write mode to the first data write mode in accordance with a data write mode designating command provided from the host device.

This enables the memory device in the second data write mode to switch its write mode to the first data write mode in accordance with the data write mode designating command provided from the host device.

A fourth aspect of the present invention provides the memory device of the first aspect of the present invention in which the memory controller unit switches the data write mode to the first data write mode in accordance with a second data write mode end command provided from the host device.

A fifth aspect of the present invention provides the memory device of one of the first to fourth aspects of the present invention in which the memory controller unit relocates data that has been written in the second data write mode in the physical address space of the nonvolatile memory in a manner that a logical address of the data and a physical address of the data correspond to each other for each memory allocation unit in accordance with a data relocation command provided from the host device.

This memory device relocates data in the MAU that has been written in the second data write mode in accordance with the data relocation command provided from the host device. After the data relocation, the memory device can manage the data in the same manner as for data written in the first data write mode. The memory device prevents data fragmentation, and enables data to be managed efficiently.

A sixth aspect of the present invention provides the memory device of one of the first to fourth aspects of the present invention in which when data that has been written in the second data write mode is partially erased in response to a data erasure command provided from the host device, the memory controller unit relocates the remaining data in the physical address space of the nonvolatile memory in a manner that the remaining data is arranged in a data arrangement identical to a data arrangement used in data writing performed in the first data write mode.

This enables the memory device to perform the relocation processing together with erasure caused by an erasure command.

A seventh aspect of the present invention provides the memory device of one of the first to sixth aspects of the present invention in which the memory controller unit sets a file system information write mode by switching to a first file system information write mode or to a second file system information write mode as designated by the host device and controls writing of file system information to the nonvolatile memory to be performed in the set file system information write mode. The memory controller unit performs processes (1) and (2) below.

(1) When writing file system information in the first file system information write mode, the memory controller unit controls a plurality of different pieces of file system information that are designated to be written using different write commands provided from the host device to be written sequentially to the nonvolatile memory in response to each write command received from the host device.

(2) When writing file system information in the second file system information write mode, the memory controller unit controls a plurality of different pieces of file system information that are designated to be written using different write commands provided from the host device to be written collectively into the same page of the nonvolatile memory.

This memory device can use the second file system information write mode when, for example, writing a plurality of different files of file system information, and can write the data in the same page of the same MAU of the nonvolatile memory. This structure shortens the total period required to write a plurality of different pieces of file system information. As a result, the host device used together with this memory device is required to store a smaller amount of data while the host device is in transmission wait state. This prevents the buffer size of the host device from increasing. This structure further shortens the transmission wait time of the host device. The use of this memory device easily enables real-time recording of a plurality of files.

An eighth aspect of the present invention provides the memory device of the seventh aspect of the present invention in which the memory controller unit writes the file system information in the first file system information write mode in an initial state when the memory device is powered on or reset, and switches the file system information write mode to the second file system information write mode in accordance with a file system information write mode designating command provided from the host device.

A ninth aspect of the present invention provides the memory device of the seventh aspect of the present invention in which the memory controller unit switches the file system information write mode to the first file system information write mode in accordance with a file system information write mode switching command provided from the host device.

A tenth aspect of the present invention provides the memory device of the seventh aspect of the present invention in which the memory controller unit switches the file system information write mode to the first file system information write mode in accordance with a second file system information write mode end command provided from the host device.

An eleventh aspect of the present invention provides the memory device of one of the eighth to tenth aspects of the present invention in which the memory controller unit relocates file system information that has been written in the second file system information write mode in the physical address space of the nonvolatile memory in a manner that the file system information is stored into a different physical page in accordance with a file system information relocation command provided from the host device.

This memory device relocates file system information in the MAU that has been written in the second file system information write mode in accordance with the file system information relocation command provided from the host device. After the relocation, the memory device can manage the file system information in the same manner as for file system information written in the first file system information write mode. As a result, this memory device prevents data fragmentation, and enables file system information to be managed efficiently.

A twelfth aspect of the present invention provides a host device that writes data to a memory device and reads data from the memory device. The host device includes a memory-device control unit.

The memory-device control unit provides a command to the memory device and controls input and output of data to be written to the memory device or data to be read from the memory device, and manages a logical address space in memory allocation units and controls data and file system information corresponding to the data to be written in different memory allocation units.

The memory-device control unit controls a data write mode of the memory device to switch to the first data write mode or to the second data write mode as designated by the memory-device control unit.

This host device controls the data write mode of the memory device to switch to the first data write mode or to the second data write mode as designated using, for example, a command. When, for example, a single file of data is to be written, the host device designates the first data write mode to be used for data writing. When a plurality of files of data are to be recorded in real time, the host device designates the second data write mode to be used for data writing. In this manner, the host device designates optimum processing to be performed by the memory device in accordance with intended use.

A thirteenth aspect of the present invention provides the host device of the twelfth aspect of the present invention in which the memory-device control unit controls the memory device to operate in the first data write mode in an initial state when the memory device is powered on or reset, and subsequently provides a data write mode designating command to the memory device to switch the data write mode of the memory device to the second data write mode.

A fourteenth aspect of the present invention provides the host device of the twelfth or thirteenth aspect of the present invention in which the memory-device control unit provides a data write mode designating command to the memory device to switch the data write mode of the memory device to the first data write mode.

A fifteenth aspect of the present invention provides the host device of the twelfth or thirteenth aspect of the present invention in which the memory-device control unit provides a second data write mode end command to the memory device to switch the data write mode of the memory device to the first data write mode.

A sixteenth aspect of the present invention provides the host device of one of the twelfth to fifteenth aspects of the present invention in which the memory-device control unit provides a data relocation command to cause the memory device to relocate data that has been written by the memory device in the second data write mode in the physical address space of the nonvolatile memory in a manner that the data is arranged in a data arrangement identical to a data arrangement used in data writing performed in the first data write mode.

A seventeenth aspect of the present invention provides the host device of the sixteenth aspect of the present invention in which when data that has been written to the memory device in the second data write mode is partially erased in a file system by updating file system information, the memory-device control unit controls the memory device to relocate data that has been written by the memory device in the second data write mode in the physical address space of the nonvolatile memory in a manner that the data is arranged in a data arrangement identical to a data arrangement used in data writing performed in the first data write mode.

An eighteenth aspect of the present invention provides the host device of one of the twelfth to seventeenth aspects of the present invention in which the memory-device control unit controls a file system information write mode of the memory device to switch to a first file system information write mode or to a second file system information write mode as designated by the memory-device control unit.

A nineteenth aspect of the present invention provides the host device of the eighteenth aspect of the present invention in which the memory-device control unit controls the memory device to operate in the first file system information write mode in an initial state when the memory device is powered on or reset, and subsequently provides a file system information write mode designating command to the memory device to switch the file system information write mode of the memory device to the second file system information write mode.

A twentieth aspect of the present invention provides the host device of the eighteenth aspect of the present invention in which the memory-device control unit provides a file system information write mode designating command to the memory device to switch the file system information write mode of the memory device to the first file system information write mode.

A twenty-first aspect of the present invention provides the host device of the eighteenth aspect of the present invention in which the memory-device control unit provides a second file system information write mode end command to the memory device to switch the file system information write mode of the memory device to the first file system information write mode.

A twenty-second aspect of the present invention provides the host device of one of the eighteenth to twenty-first aspects of the present invention in which the memory-device control unit provides a file system information relocation command to the memory device to cause the memory device to relocate data that has been written by the memory device in the second file system information write mode in the physical address space of the nonvolatile memory in a manner that the data is arranged in a data arrangement identical to a data arrangement used in data writing performed in the first file system information write mode.

A twenty-third aspect of the present invention provides a memory system including the memory device of one of the first to eleventh aspects of the prevent invention, and the host device of one of the twelfth to twenty-second aspects of the present invention.

### ADVANTAGEOUS EFFECTS

The memory device, the host device, and the memory system of the present invention enable real-time recoding of a plurality of pieces of moving image data while preventing the buffer size of the host device from increasing.

### BRIEF DESCRIPTION OF DRAWINGS

FIG. 1 is a block diagram of a nonvolatile memory system 1000 according to a first embodiment of the present invention.

FIG. 2 is a diagram describing a first data write mode.

FIG. 3 is a diagram describing a second data write mode.

FIG. 4 is a diagram describing state transition of data write modes.

FIG. 5 is a diagram describing command sequences for switching data write modes.

FIG. 6 is a diagram describing a first file system information write mode.

FIG. 7 is a diagram describing a second file system information write mode.

FIG. 8 is a diagram describing state transition of file system information write modes.

FIG. 9 is a diagram describing command sequences for switching file system information write modes.

FIG. 10 is a diagram describing the processing for relocating data.

FIG. 11 is a diagram describing relocation of file system information.

FIG. 12 is a diagram describing the processing for relocating data performed when an erase command is generated.

FIG. 13 is a diagram describing the processing for relocating data performed after a file system operation is performed.

FIG. 14 is a diagram describing transactions occurring on a bus 3.

FIG. 15 is a diagram describing the structure of a command CMD, a response RES, and data DAT.

### REFERENCE SIGNS LIST

1000 nonvolatile memory system (memory system)
1 memory device
11 memory controller unit
110 host IF unit
111 command processing unit
112 memory management unit
1121 CPU
1122 register
1123 data writing management unit
1124 file-system-information writing management unit
113 data control unit
12 nonvolatile memory
2 host device
21 CPU
22 ROM
23 RAM
24 buffer RAM
25 memory-device control unit
3 bus

### DESCRIPTION OF EMBODIMENTS

Embodiments of the present invention will now be described with reference to the drawings.

### First Embodiment

### 1.1 Structure of Nonvolatile Memory System

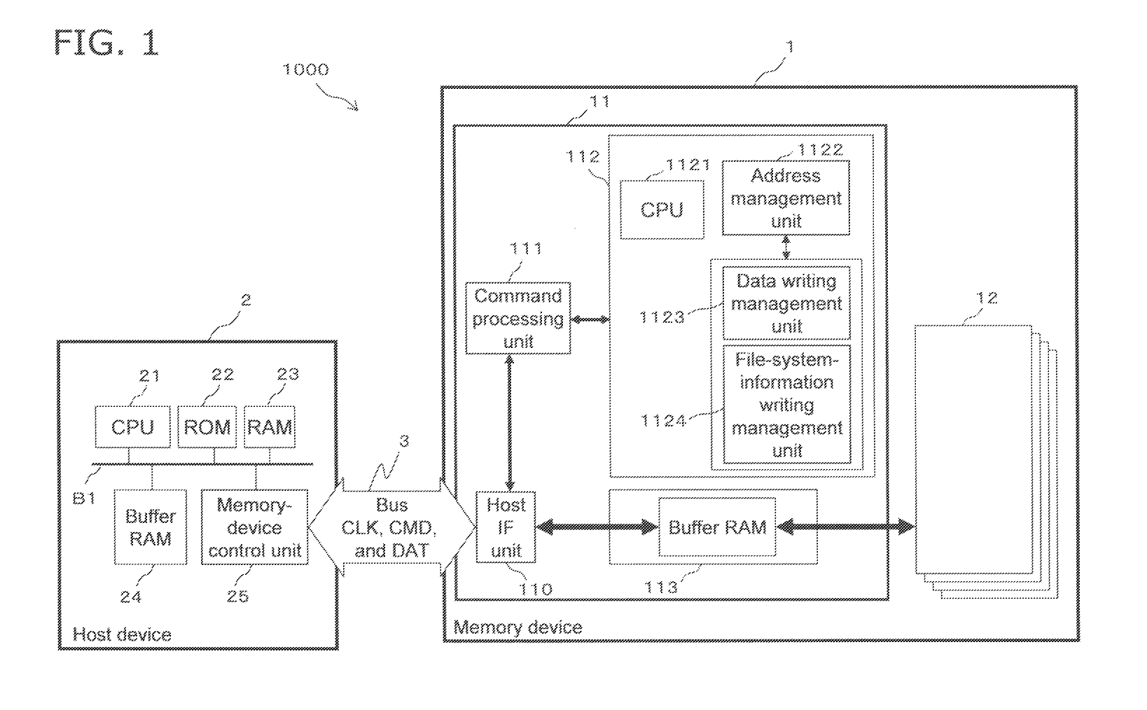

FIG. 1 is a block diagram showing the structure of a nonvolatile memory system (memory system) 1000 according to a first embodiment of the present invention.

As shown in FIG. 1, the nonvolatile memory system 1000 of the present embodiment includes a memory device 1 and a host device 2. The memory device 1 and the host device 2 are connected to each other with a bus 3, via which bidirectional data communication can be performed between the devices.

The drawings used in the embodiment only show components that are pertinent to the present invention. The present invention should not be limited to the embodiment described below.

### 1.1.1 Memory Device

As shown in FIG. 1, the memory device 1 includes a memory controller unit 11 and at least one nonvolatile memory 12.

As shown in FIG. 1, the memory controller unit 11 includes a host IF unit 110, a command processing unit 111, a memory management unit 112, and a data control unit 113.

The host IF unit 110 is connected to the host device 2 with the bus 3, via which the host IF unit 110 can communicate with the host device 2. The host IF unit 110 receives a command from the host device 2 or transmits a response to the host device 2 via the bus 3. The host IF unit 110 transmits and receives data to and from the host device 2 via the bus 3. The host IF unit 110 outputs a command received from the host device 2 to the command processing unit 111, and outputs data received from the host device 2 to the data control unit 113. The host IF unit 110 receives input of, for example, a response output from the command processing unit 111, and transmits the received response to the host device 2 via the bus 3.

The command processing unit 111 interprets the command generated by the host device 2 and received by the host IF unit 110, and generates a response to be transmitted to the host device 2, and outputs the response to the host IF unit 110. The command processing unit 111 further outputs the interpretation result of the command or data obtained using an argument included in the command to the memory management unit 112.

The memory management unit 112 manages input and output of data to and from the nonvolatile memory 12 and also manages the memory area of the nonvolatile memory 12.

The memory management unit 112 includes a CPU 1121 and an address management unit 1122. The CPU 1121 controls the overall processing of the memory device 1. The address management unit 1122 manages the correspondence between a logical address included in a command generated by the host device 2 and a physical address defined in the nonvolatile memory 12. The memory management unit 112 includes a data writing management unit 1123 and a file-system-information writing management unit 1124. The data writing management unit 1123 manages a write mode in which data is written to the nonvolatile memory 12. The file-system-information writing management unit 1124 manages a write mode in which file system information is written to the nonvolatile memory 12.

The data control unit 113 includes a buffer RAM used when data is input and output between the host IF unit 110 and the nonvolatile memory 12. Using the buffer RAM, the data control unit 113 performs a data writing process for writing data to the nonvolatile memory 12 and a data reading process for reading data from the nonvolatile memory 12 in accordance with a command provided from the memory management unit 112.

Some or all of the functional units of the memory controller unit 11 may be connected to one another independently or may be connected to one another using an internal bus.

### 1.1.2 Host Device

As shown in FIG. 1, the host device 2 includes a CPU 21, a ROM 22, a RAM 23, a buffer RAM 24, and a memory-device control unit 25. The CPU 21 controls the overall operation of the host device 2. The buffer RAM 24 is used to transmit and receive data to and from the memory device 1. The memory-device control unit 25 transmits and receives a command, a response, and data to and from the memory device 1 via the bus 3.

Some or all of the functional units of the host device 2 may be connected to one another independently or may be connected to one another using an internal bus (for example, the bus B1 in FIG. 1).

### 1.1.3 Bus

The bus 3 consists of one or more signal lines used by the memory device 1 and the host device 2 to transmit and receive a command, a response, and data. The bus 3 used in the nonvolatile memory system 1000 of the present embodiment includes a clock line for transmitting a clock signal CLK, a command line for transmitting a command and response signal CMD, and a data signal line for transmitting a data signal DAT. The bus 3 may include a plurality of data signal lines instead of including only a single data signal line.

### Bus Transactions

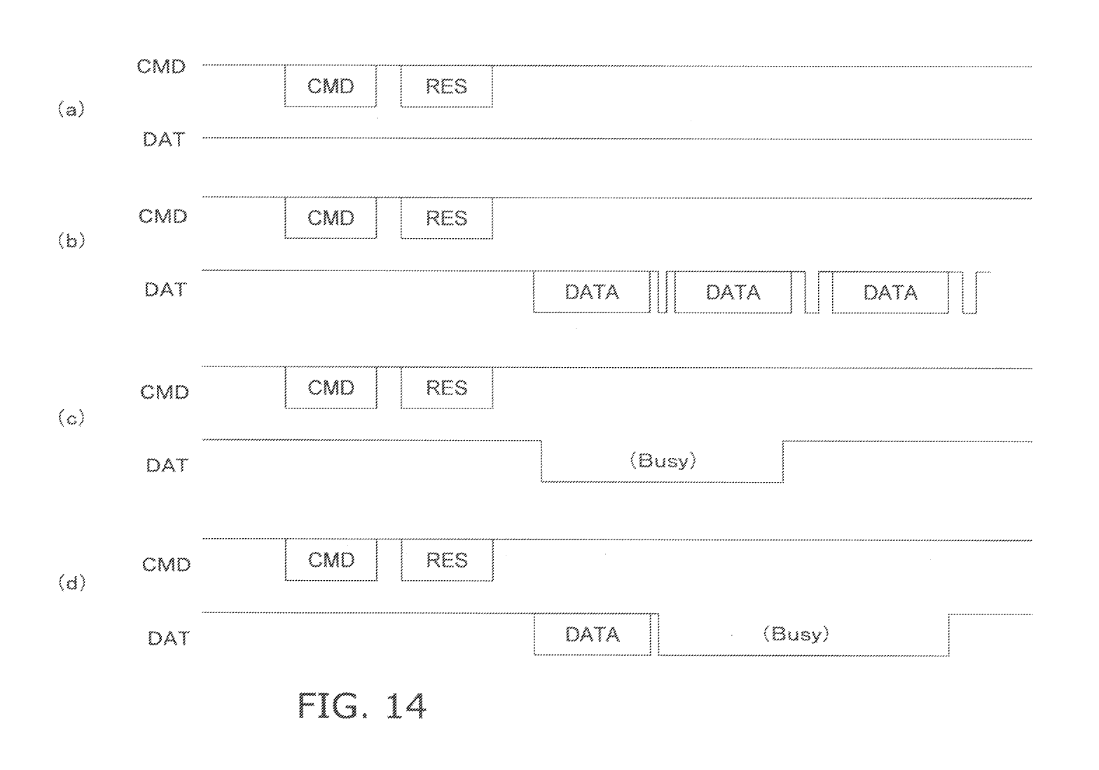

FIG. 14 is a diagram describing bus transactions performed by the memory device 1 and the host device 2 via the bus 3 in the nonvolatile memory system 1000.

In FIG. 14, the command CMD is a signal transmitted from the host device 2 to the memory device 1 to cause reading or writing of data.

The response RES is a signal transmitted by the memory device 1 to provide status information in response to the received command CMD.

When data is written to the memory device, the data DAT is transmitted from the host device 2 to the memory device 1. When data is read from the memory device 1, the data DAT is transmitted from the memory device 1 to the host device 2.

These transactions are processed mainly by the command processing unit 111 and the host IF unit 110 included in the memory device 1 and the memory-device control unit 25 included in the host device 2. The transactions may also involve the processing performed by the memory management unit 112 included in the memory device 1 when necessary.

A plurality of different bus transactions may be performed in accordance with commands generated by the host device 2. FIG. 14(a) shows a transaction involving simply a command CMD and a response RES. This transaction is performed mainly when the command does not require input and output of data to and from the nonvolatile memory 12.

FIG. 14(b) shows a transaction involving transfer of data DAT in addition to a command CMD and a response RES. This bus transaction is performed mainly when data is written to the nonvolatile memory 12 and data is read from the nonvolatile memory 12.

A bus transaction shown in FIG. 14(c) involves transmission of a Busy signal to the host device 2 in addition to a command CMD and a response RES. The Busy signal indicates the state of the memory device 1 that is performing internal processing using the data DAT.

A bus transaction shown in FIG. 14(d) involves a command CMD, a response RES, and data DAT, and then transmission of a Busy state signal (Busy signal) from the memory device 1 to the host device 2.

As shown in FIGS. 14(c) and 14(d), the memory device 1 transmits a Busy state signal (Busy signal) when the memory device 1 is disabled to input and output data with the host device 2 and the memory device 1 is only enabled to perform internal processing of inputting and outputting data into and from the nonvolatile memory 12 using the memory controller unit 11. In this case, the bus transactions shown in FIGS. 14(c) and 14(d) are performed in the nonvolatile memory system 1000.

### Data Format

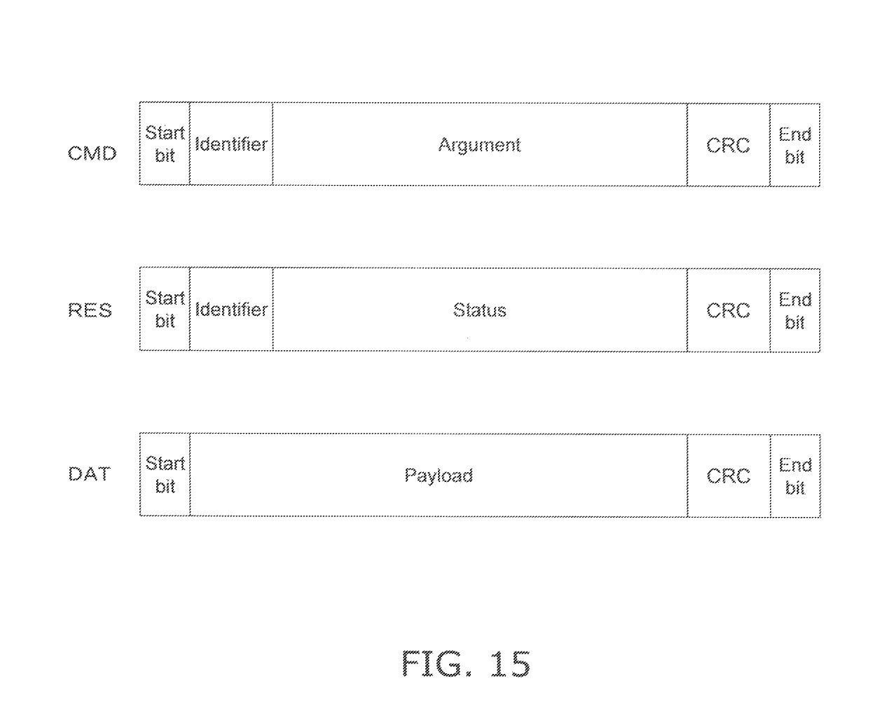

FIG. 15 shows the structure of a command CMD, a response RES, and data DAT transmitted and received between the memory device 1 and the host device 2. In FIG. 15, the command CMD, the response RES, and the data DAT commonly include a start bit, an end bit, and a CRC for detecting an error on the bus 3. The other components differ depending on the command CMD, the response RES, and the data DAT.

The command CMD includes an identifier for identifying the processing to be caused by the host device 2 and an argument. The argument of the command CMD contains flags associated with various controls and address information for reading and writing data. The argument included in the command CMD differs depending on the identifier included in the command CMD.

The response RES includes an identifier and a status. The identifier of the response RES has the same value as the identifier of the command CMD generated by the host device 2. The status of the response RES is a state signal indicating the internal state of the memory device 1. For example, the state signal contains information indicating whether an error has occurred in the memory device 1 or information indicating the state change of the memory device 1.

The data DAT includes a payload. The payload differs depending on the identifier of the command CMD generated by the host device 2. When the command CMD is a read command for reading data from the nonvolatile memory 12 or a write command for writing data to the nonvolatile memory 12, the payload contains data read from the nonvolatile memory 12 or data to be written to the nonvolatile memory 12. When the command CMD is a read command for reading a register, the payload contains the value of the register.

### 1.2 Operation of Nonvolatile Memory System

The operation of the nonvolatile memory system 1000 will now be described with reference to the drawings. In this example, the host device 2 writes two files of data and file system management information for the two files of data to the memory device 1.

### 1.2.1 Data Write Modes

The data write modes used in the nonvolatile memory system 1000, namely the first data write mode and the second data write mode, will now be described.

### 1.2.1.1 First Data Write Mode

The first data write mode used in the nonvolatile memory system 1000 will first be described.

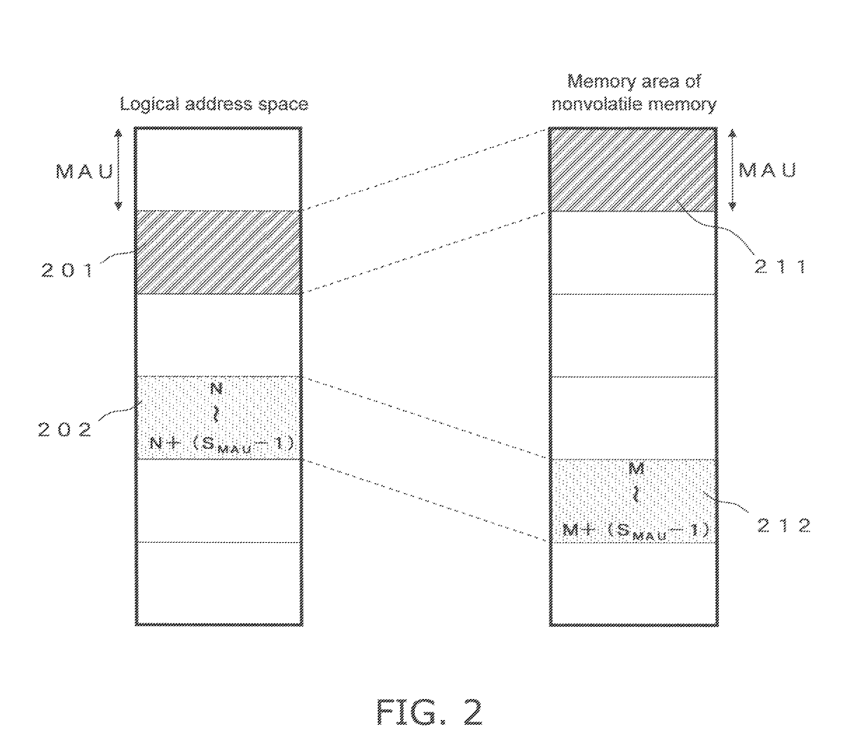

FIG. 2 shows the first data write mode of the memory device 1 according to the present embodiment.

In FIG. 2, the logical address space managed by the host device 2 and the memory area of the nonvolatile memory managed by the memory device 1 are both managed in memory allocation units (MAUs). The address management unit 1122 included in the memory device 1 manages the correspondence between MAUs in the logical address space and MAUs in the memory area of the nonvolatile memory. The MAU has a size unique to the memory device 1. When, for example, the nonvolatile memory is a NAND flash memory, the size of the MAU may be, for example, an integral multiple of the size of a physical block, which is a unit of erasure used in the memory area of a NAND-flash memory.

When the host device 2 transmits a write command for writing data in the first data write mode to the memory device 1, the address management unit 1122 associates an MAU having a logical address included in the command with an MAU in the memory area of the nonvolatile memory, and writes target data designated using the write command transmitted by the host device 2 (write data) into the selected area.

In FIG. 2, an MAU 201 in the logical address space is associated with an MAU 211 in the memory area of the nonvolatile memory, and an MAU 202 in the logical address space is associated with an MAU 212 in the memory area of the nonvolatile memory.

Each MAU contains data arranged continuously. Each MAU has a size of S_{MAU} bytes. In this case, for example, data having byte addresses N to N+S_{MAU}−1 in the MAU 202 in the logical address space is recorded at byte addresses M to M+S_{MAU}−1 in the MAU 212 in the memory area of the nonvolatile memory. In other words, the data arrangement in the MAU 202 is identical to the data arrangement in the MAU 212.

When the host device 2 writes data continuously to the memory device 1 in the nonvolatile memory system 1000, the use of the first data write mode enables the data to be written into a continuous area included in the memory area of the nonvolatile memory 12. This enables the data to be written efficiently in a short time.

### 1.2.1.2 Second Data Write Mode

The second data write mode used in the nonvolatile memory system 1000 will now be described.

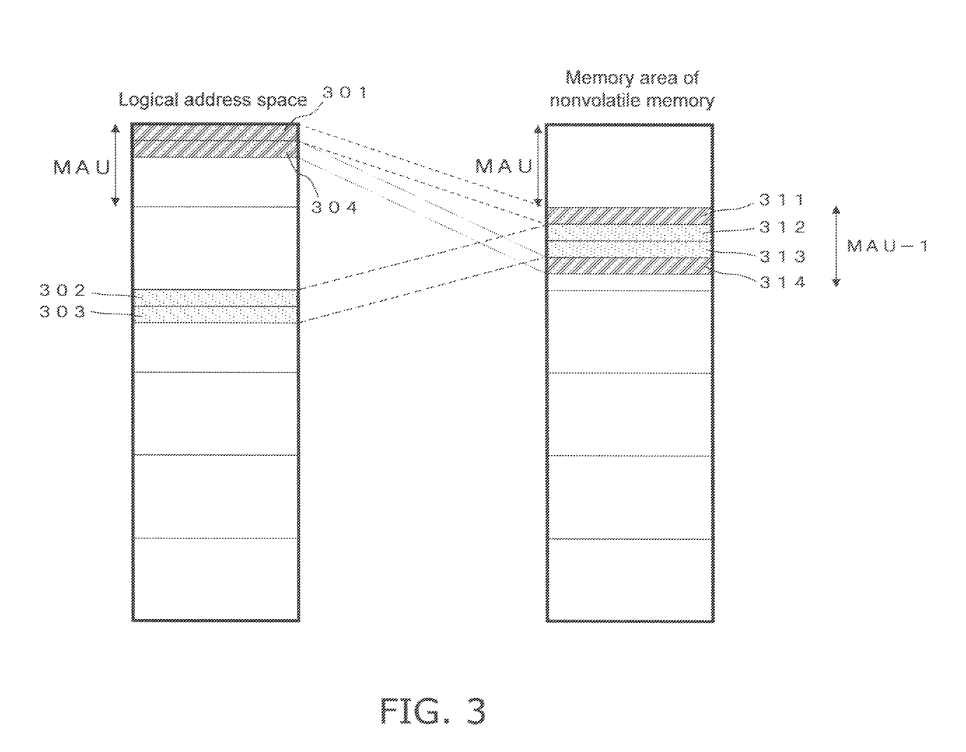

FIG. 3 shows the second data write mode of the memory device 1 according to the present embodiment.

In the same manner as for the first data write mode, the logical address space managed by the host device 2 and the memory area of the nonvolatile memory managed by the memory device 1 are both managed in memory allocation units (MAUs) in FIG. 3. The address management unit 1122 included in the memory device 1 then manages the correspondence between the logical address space and the memory area of the nonvolatile memory 12. However, the second data write mode differs from the first data write mode in that data belonging to different MAUs in the logical address space is recorded continuously in the same MAU in the memory area of the nonvolatile memory 12.

As shown in FIG. 3, when the host device 2 transmits a write command for writing data in the second data write mode to the memory device 1, the address management unit 1122 selects an MAU in the memory area of the nonvolatile memory 12, and writes target data designated using the write command transmitted by the host device 2 (write data) into the selected area. In the nonvolatile memory system 1000, the host device 2 thereafter writes data in the second data write mode in response to write commands continuously in the same MAU (an MAU−1 in FIG. 3) in the memory area of the nonvolatile memory 12 irrespective of a logical address included in each write command.

As shown in FIG. 3, in the nonvolatile system 1000, when the host device 2 writes a plurality of pieces of data 301 to 304 belonging to two different MAUs in the second data write mode in the order of the data pieces 301, 302, 303, and 304, the memory management unit 112 manages the memory in a manner that these data pieces are written continuously into a single writable MAU (an MAU−1 in FIG. 3) included in the memory area of the nonvolatile memory in the manner described below.

(1) The data piece 301 is written into an area 311.

(2) The data piece 302 is written into an area 312.

(3) The data piece 303 is written into an area 313.

(4) The data piece 304 is written into an area 314.

In the manner described above, the data is recorded continuously in the memory area of the nonvolatile memory 12 in the second data write mode in the nonvolatile memory system 1000.

The address management unit 1122 manages the correspondence between the logical addresses of the data pieces 301 to 304 and the physical addresses of the areas 311 to 314 in the memory area of the nonvolatile memory 12.

As described above, when the host device 2 writes a plurality of pieces of data belonging to different MAUs alternately in the memory device 1 in the nonvolatile memory system 1000, the use of the second data write mode enables the data with the discontinuous logical addresses to be written continuously in the memory area of the nonvolatile memory 12. This enables the data to be written efficiently in a short time in the nonvolatile memory system 1000.

In the nonvolatile memory system 1000, in order to record a plurality of files of data arranged in different MAUs of the logical address space onto the memory device 1, whose performance is defined as the performance measured when data having the size of an MAU is written, the host device 2 is only required to have the same buffer size as required when a single file is recorded. As a result, the nonvolatile memory system 1000 enables real-time recording of a plurality of files of data (data writing guaranteeing a predetermined writing speed) to be performed without increasing the required buffer size of the host device 2 (while allowing the host device 2 only to have the same buffer size as required when a single file is recorded).

The address management unit 1122 may use one of the various methods known in the art for managing the correspondence between the logical address space and the memory area of the nonvolatile memory (the correspondence between the data arrangement in predetermined divisional areas (for example MAUs) in the logical address space and predetermined divisional areas (for example MAUs) in the memory area (physical address space) of the nonvolatile memory). Such conventional methods are not directly pertinent to the gist of the present invention and will not be described.

1.2.1.3 State transition diagram of Data Write Modes

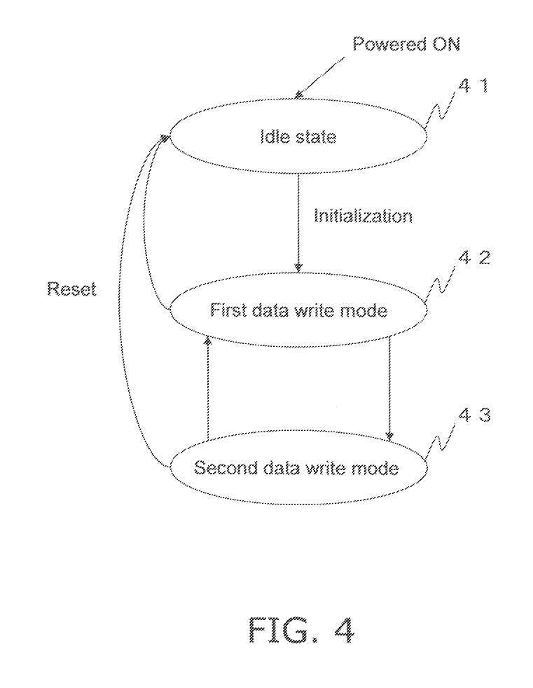

FIG. 4 is a state transition diagram of the data write modes of the memory device 1 according to the present embodiment.

As shown in FIG. 4, the memory device 1 enters an IDLE state 41 when the device is powered on or when the device is reset. When initialized by the host device 2, the memory device 1 shifts to the first data write mode 42. Subsequently, the memory device 1 switches between the first data write mode 42 and the second data write mode 43 in accordance with a command provided from the host device 2, and writes data to the nonvolatile memory 12 in the selected mode.

1.2.1.4 Command Sequences Associated with Data Write Modes

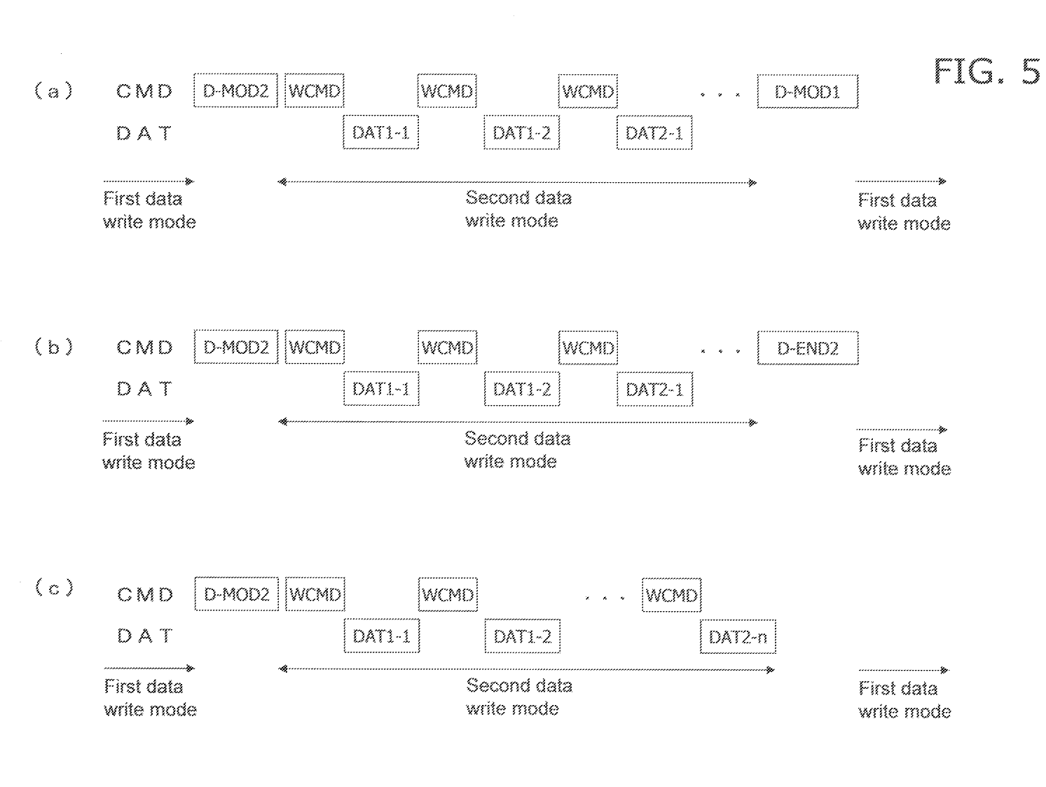

FIG. 5 is a diagrams describing command sequences for switching between the first data write mode 42 and the second data write mode 43 in FIG. 4.

FIGS. 5(a) to 5(c) schematically show commands transmitted from the host device 2 to the memory device 1 via the bus 3 in the upper portion, and data transmitted from the host device 2 to the memory device 1 via the bus 3 in the middle portion, and the data write modes in the lower portion. In FIGS. 5(a) to 5(c), the lateral axis is the time axis.

In FIGS. 5(a) to 5(c), commands D-MOD1 and D-MOD2 each cause one of the sequences shown in FIGS. 14(a) to 14(d). To simply the drawings, details of the sequences caused by the commands D-MOD1 and D-MOD2 and the like are not shown in FIGS. 5(a) to 5(c).

As shown in FIGS. 5(a) to 5(c), when the memory device 1 receives the data write mode switching command D-MOD2 generated by the host device 2, the memory device 1 switches the data write mode from the first data write mode 42 to the second data write mode 43. When receiving a write command from the host device 2 after the mode switching to the second data write mode, the data writing management unit 1123 controls data to be written to the nonvolatile memory 12 in the second data write mode.

As shown in FIG. 5(a), when the memory device 1 receives the data write mode switching command D-MOD1 generated by the host device 2, the memory device 1 switches the data write mode from the second data write mode 43 to the first data write mode 42. When receiving a write command from the host device 2 after the mode switching to the first data write mode, the data writing management unit 1123 controls data to be written to the nonvolatile memory 12 in the first data write mode.

As shown in FIGS. 5(b) and 5(c), the memory device 1 may switch the data write mode from the second data write mode 43 to the first data write mode 42.

More specifically, as shown in FIG. 5(b), when the memory device 1 receives a second data write mode end command D-END2 generated by the host device 2, the memory device 1 switches the data write mode to the first data write mode 42.

As shown in FIG. 5(c), the memory device 1 switches the data write mode to the first data write mode 42 after writing data to the nonvolatile memory 12 a predetermined number of times in the second data write mode. The predetermined number of times may be set by the host device 2 and transmitted to the memory device 1 by using the argument included in the data write mode switching command D-MOD2 generated by the host device 2. Alternatively, the register included in the memory device 1 may prestore a value indicating the predetermined number of times.

As described above, the memory device 1 of the present embodiment switches the data write mode to either the first data write mode or the second data write mode in response to a command generated by the host device 2 of the present embodiment and writes data to the nonvolatile memory in the set data write mode. It is preferable that the command D-MOD2 includes information indicating the number of files to be written using the second data write mode and information identifying each file.

As a result, the nonvolatile memory system 1000 enables a plurality of files of data to be written into the same MAU of the nonvolatile memory. To record a plurality of files in the nonvolatile memory system 1000, the host device 2 is only required to have the same buffer size as required when a single file is recorded.

### 1.2.2 File System Information Write Modes

The file system information write modes used in the nonvolatile memory system 1000, namely the first file system information write mode and the second file system information write mode, will now be described.

### 1.2.2.1 First File System Information Write Mode

The first file system information write mode used in the nonvolatile memory system 1000 will first be described.

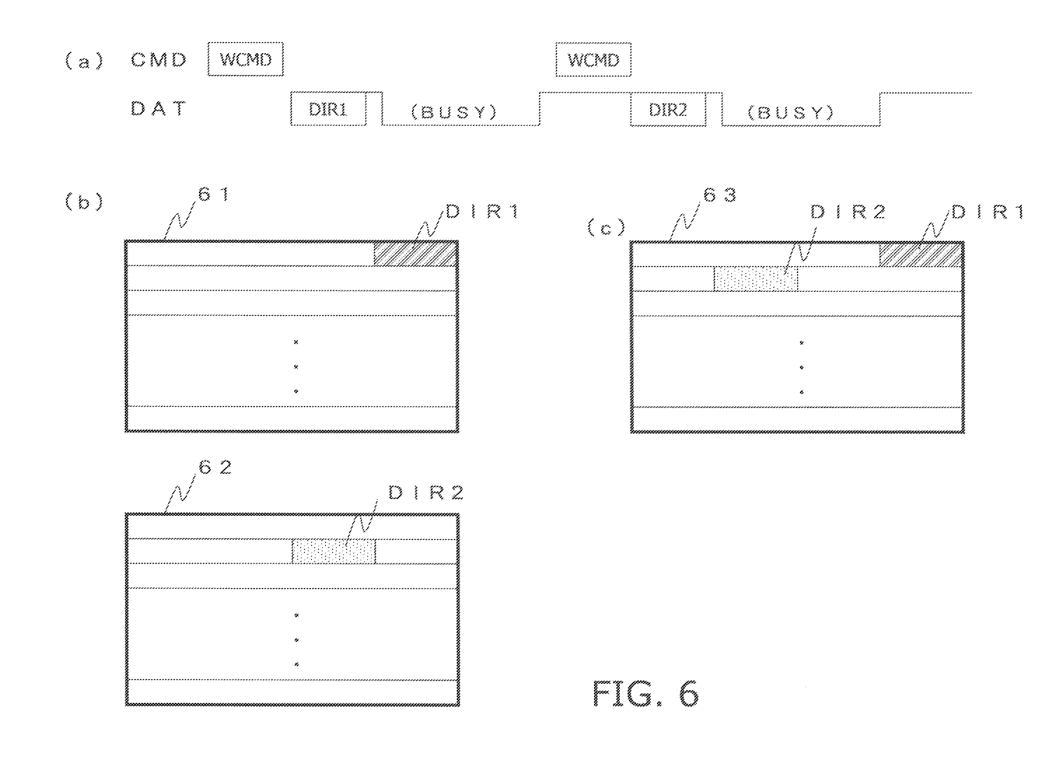

FIG. 6 shows the first file system information write mode of the memory device 1 according to the present embodiment.

In FIG. 6, the memory area of the nonvolatile memory is managed by the memory device 1 in memory allocation units (MAUs). The address management unit 1122 included in the memory device 1 manages the correspondence between logical addresses at which file information is written by the host device 2 and physical addresses in the nonvolatile memory.

FIG. 6(a) is a diagram describing command sequences used when the host device 2 writes file system information DIR1 and file system information DIR2 using different write commands WCMD.

In FIG. 6(a), when the memory device 1 receives the file system information DIR1 or the file system information DIR2 after receiving a write command WCMD, the memory device 1 transmits a Busy signal to the host device 2 and writes the file system information received from the host device 2 to the nonvolatile memory 12. In this case, the memory device 1 may write the file system information DIR1 and the file system information DIR2 in different MAUs 61 and 62 as shown in FIG. 6(b), or may write the file system information DIR1 and the file systemrg information DIR2 in the same MAU63 as shown in FIG. 6(c). The file system information DIR1 and the file system information DIR2 normally correspond to different pieces of data. Thus, the logical addresses for the file system information DIR1 and the file system information DIR2 are normally discontinuous addresses, and the file system information DIR1 and the file system information DIR2 are written into different pages in both the examples shown in FIGS. 6(b) and 6(c). The page is a unit for writing data to the nonvolatile memory 12, and may for example be a page defined for a NAND flash memory.

### 1.2.2.2 Second File System Information Write Mode

The second file system information write mode used in the nonvolatile memory system 1000 will now be described.

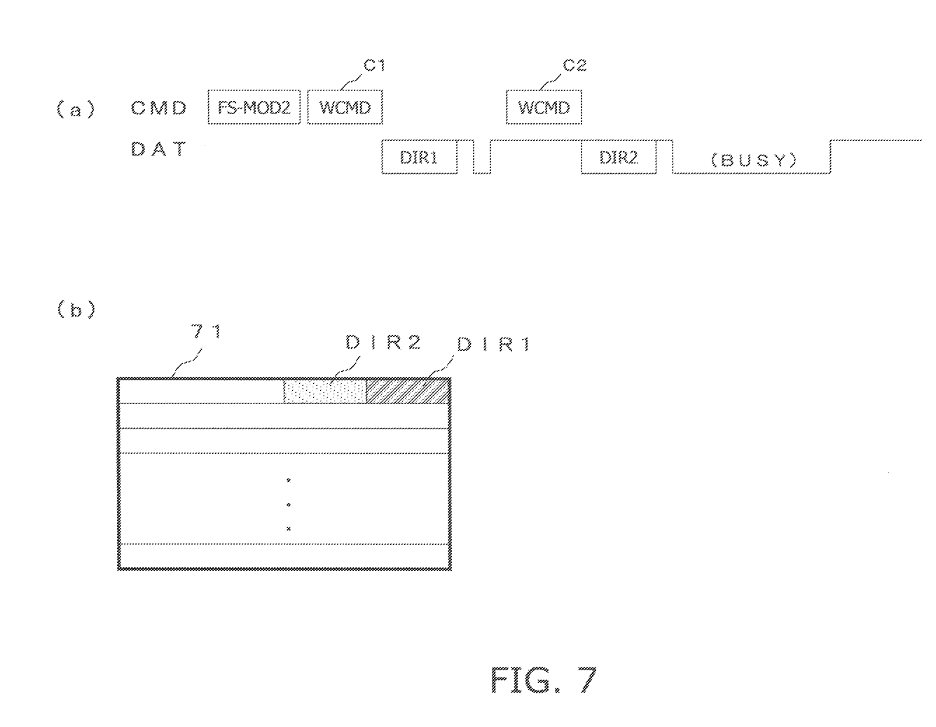

FIG. 7 shows the second file system information write mode of the memory device 1 according to the present embodiment.

FIG. 7(a) is a diagram describing command sequences used when the host device 2 writes file system information DIR1 and file system information DIR2 using different write commands WCMD.

In FIG. 7(a), the host device 2 first transmits a file system information write mode switch command FS-MOD2 to the memory device 1. The host device 2 subsequently transmits write commands WCMD to the memory device 1. In response to the commands, the memory device 1 writes the file system information DIR1 and the file system information DIR2.

The memory device 1 first receives the command FS-MOD2 from the host device 2. Subsequently, when receiving the command WCMD for writing the file system information DIR1 (the write command WCMD with reference numeral C1 in FIG. 7(a)) among the write commands WCMD generated after the command FS-MOD2 is generated, the memory device 1 receives the file system information DIR1, and is set in a state in which the memory device can receive the next command WCMD without writing the received file system information DIR1 to the nonvolatile memory 12. This also shortens the period during which a Busy signal is being output from the memory device 1 to the host device 2. In this case, the memory device 1 stores the file system information DIR1 into, for example, a buffer RAM included in the data control unit 113.

When receiving the next command WCMD (the write command WCMD with reference numeral C2 in FIG. 7(a)), the memory device 1 receives the next file system information DIR2, and writes the file system information DIR2 together with the previously received file system information DIR1 to the nonvolatile memory 12. The memory device 1 continues to output a Busy signal to the host device 2 until completely writing the file system information DIR1 and the file system information DIR2.

FIG. 7(b) is a diagram describing the state of an MAU included in the nonvolatile memory into which the file system information DIR1 and the file system information DIR2 are written.

In FIG. 7(b), the file system information DIR1 and the file system information DIR2 are written in the same page in the MAU71. The use of the second file system information write mode therefore shortens the total time required to write the file system information DIR1 and the file system information DIR2 in the nonvolatile memory system 1000 as compared with when the first file system information write mode described with reference to FIG. 6 is used. It is preferable that the command FS-MOD2 includes information indicating the number of files to be written using the second file system information write mode and information identifying each file.

As described above, the second file system information write mode used in the nonvolatile memory system 1000 shortens the total time required to write file system information when a plurality of files of file system information are written. This shortens the total period during which a Busy signal is being output from the memory device 1 to the host device 2, or in other words shortens the period during which the host device 2 is disabled to transmit data to the memory device 1, or the host device 2 is in transmission wait state. As a result, the nonvolatile memory system 1000 reduces the amount of data to be stored when the host device 2 is in transmission wait state, and prevents the buffer size of the host device 2 from increasing.

1.2.2.3 State transition diagram of File System Information Write modes

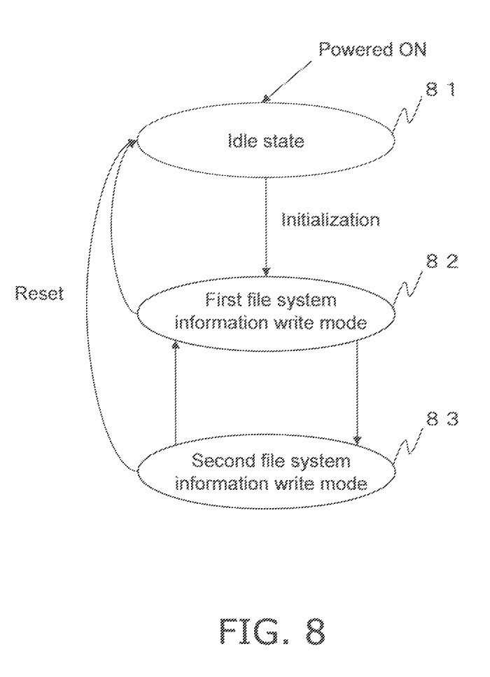

FIG. 8 is a state transition diagram of the file system information write modes of the memory device 1 according to the present embodiment.

As shown in FIG. 8, the memory device 1 enters an IDLE state 81 when the device is powered on or when the device is reset. When initialized by the host device 2, the memory device 1 shifts to the first file system information write mode 82. Subsequently, the memory device 1 switches between the first file system information write mode 82 and the second file system information write mode 83 in accordance with a command provided from the host device 2, and writes file system information to the nonvolatile memory 12 in the selected mode.

1.2.2.4 Command Sequences Associated with File System Information Write Modes

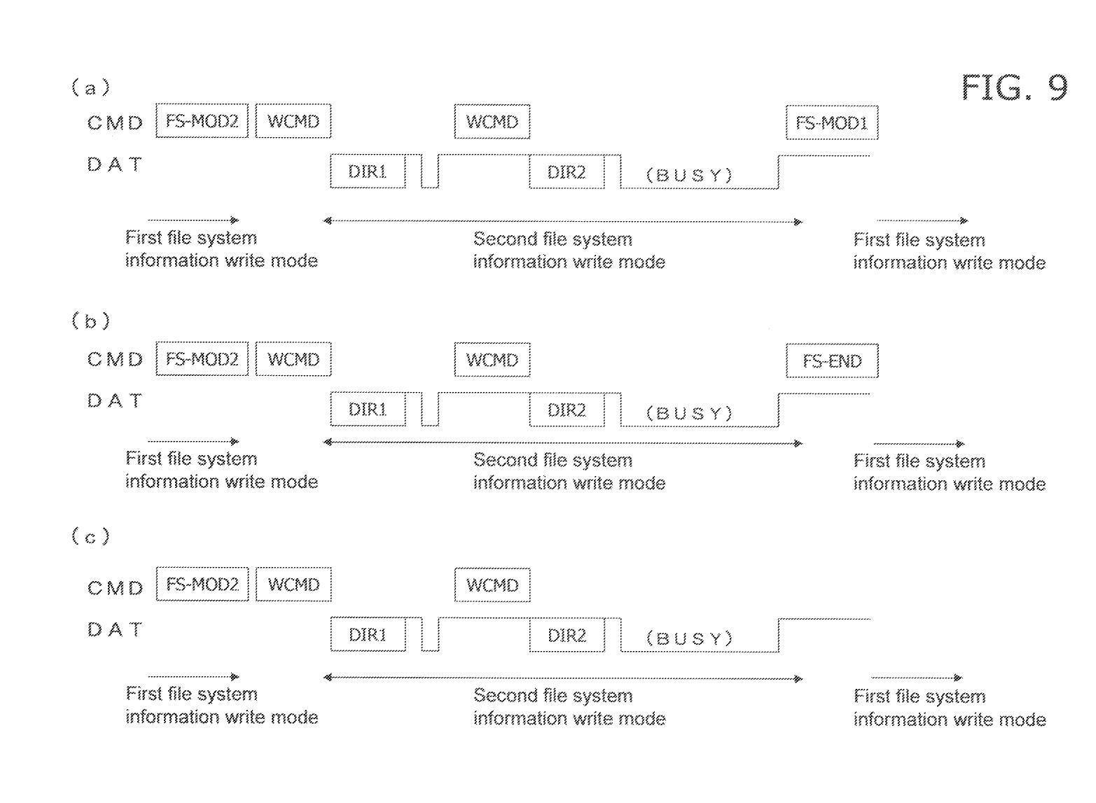

FIG. 9 is a diagram describing command sequences for switching between the first file system information write mode 82 and the second file system information write mode 83 in FIG. 8.

In FIGS. 9(a) to 9(c), commands FS-MOD1 and FS-MOD2 each cause one of the sequences shown in FIGS. 14(a) to 14(d). To simply the drawings, details of the sequences caused by the commands FS-MOD1 and FS-MOD2 and the like are not shown in FIGS. 9(a) to 9(c).

As shown in FIG. 9, when the memory device 1 receives the file system information write mode switching command FS-MOD2 generated by the host device 2, the memory device 1 switches the file system information write mode from the first file system information write mode 82 to the second file system information write mode 83. When receiving a file system information write command from the host device 2 after the mode switching to the second file system information write mode, the file-system-information writing management unit 1124 controls file system information to be written to the nonvolatile memory 12 in the second file system information write mode.

As shown in FIG. 9(a), when the memory device 1 receives the file system information write mode switching command D-MOD1 generated by the host device 2, the memory device 1 switches the file system information write mode from the second file system information write mode 83 to the first file system information write mode 82. When receiving a file system information write command transmitted from the host device 2 after the mode switching to the first file system information write mode, the file-system-information writing management unit 1124 controls file system information to be written to the nonvolatile memory 12 in the first file system information write mode.

As shown in FIGS. 9(b) and 9(c), the memory device 1 may switch the file system information write mode from the second file system information write mode 83 to the first file system information write mode 82.

More specifically, as shown in FIG. 9(b), when the memory device 1 receives a second file system information write mode end command FS-END generated by the host device 2, the memory device 1 switches the file system information write mode to the first file system information write mode 82.

As shown in FIG. 9(c), the memory device 1 switches the file system information write mode to the first file system information write mode 82 after writing file system information to the nonvolatile memory 12 a predetermined number of times in the second file system information write mode. The predetermined number of times may be set by the host device 2 and transmitted to the memory device 1 by using the argument included in the file system information write mode switching command FS-MOD2 generated by the host device 2. Alternatively, the register included in the memory device 1 may prestore a value indicating the predetermined number of times.

In the nonvolatile memory system 1000 of the present embodiment described above, the memory device 1 switches the file system information write mode to either the first file system information write mode or the second file system information write mode in response to a command generated by the host device 2 and writes file system information to the nonvolatile memory 12 in the set file system information write mode.

As a result, the nonvolatile memory system 1000 shortens the total time required to write a plurality of files of file system information to the nonvolatile memory 12, and prevents the buffer size of the host device 2 from increasing.

### 1.2.3 Relocation of Write Data

As described above, when a plurality of files of data or a plurality of files of file system information are written in the second data write mode or the second file system information write mode in the nonvolatile memory system 1000, different data files or different file system information files are recorded in the same MAU of the nonvolatile memory 12. Managing the data or the file system information recorded in this state in the nonvolatile memory system 1000 requires more complicated control than required when the data or the file system information is recorded in the first data write mode or the first file system information write mode. When, for example, a specific data file or a specific file system information file among a plurality of recorded files is erased in the nonvolatile memory system 1000, the same MAU will contain both valid data and invalid data. The nonvolatile memory system 1000 is required to manage such data fragmentation.

The complicated management can be eliminated by relocating the data written in the second data write mode and the file system information written in the second file system information write mode in a manner that the data and the file system information will be arranged in the same state as when they are written in the first data write mode and the first file system information write mode. The processing for such relocation needs to be performed.

### 1.2.3.1 Relocation Processing (Caused by Data Relocation Command and File System Information Relocation Command)

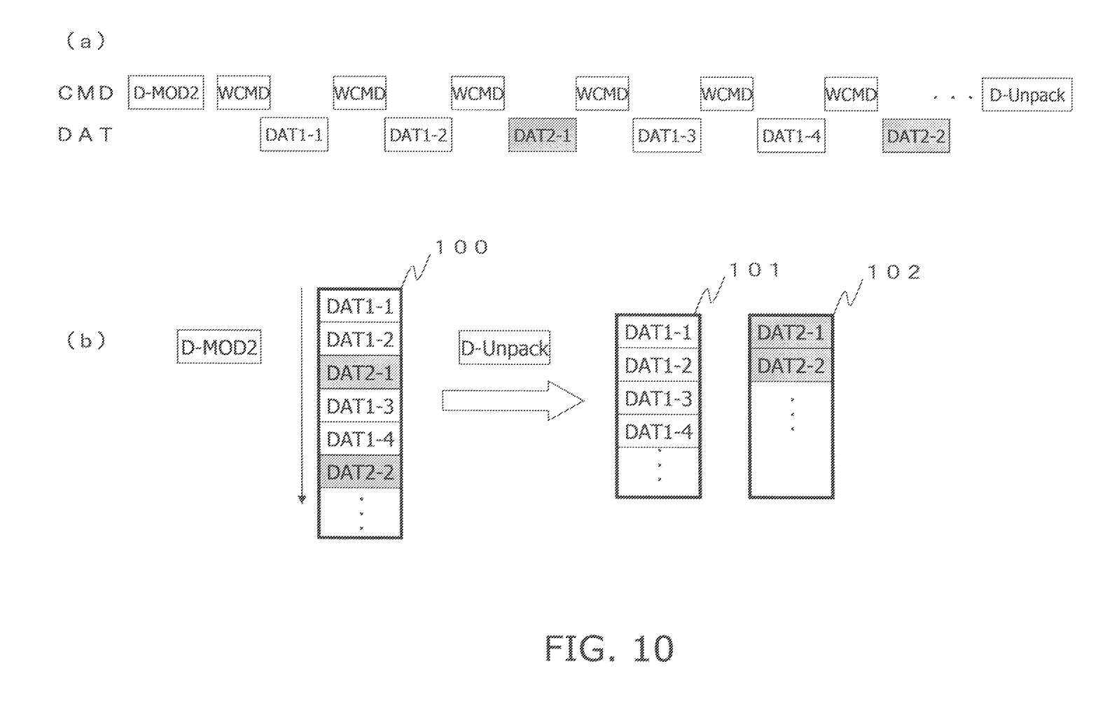

FIG. 10 is a diagram describing the processing performed in the nonvolatile memory system 1000 for relocating the data that has been recorded in the second data write mode in a manner that the data will be arranged in the same state as when it is written in the first data write mode.

FIG. 10(a) is a diagram describing command sequences associated with the relocation processing.

As shown in FIG. 10(a), the host device 2 generates a data write mode switching command D-MOD2 and transmits the command to the memory device 1. After the memory device 1 writes data in the second data write mode, the host device 2 generates a data relocating command D-Unpack and transmits the command to the memory device 1. In response to the command, the memory controller unit 11 included in the memory device 1 relocates the data in the MAU that has been written in the second data write mode to a different MAU based on its logical address.

FIG. 10(b) schematically shows the processing performed in the nonvolatile memory system 1000 for relocating data in an MAU100 that has been written in the second data write mode to an MAU101 and an MAU102.

In FIG. 10(b), the MAU100 stores data DAT1-n (n=1, 2, . . . ) and data DAT2-m (m=1, 2, . . . ) belonging to two MAUs in the logical address space. When the memory device 1 receives a data relocating command D-Unpack, the memory controller unit 11 relocates the data stored in the MAU100 into the MAU101 and the MAU102 based on its logical addresses. More specifically, the memory controller unit 11 relocates the data DAT1-n to the MAU101 and the data DAT2-m to the MAU102. The address management unit 1122 included in the memory controller unit 11 manages the logical addresses of the data DAT1-n and the data DAT2-m using the RAM (not shown) included in the memory device 1 or using the nonvolatile memory 12.

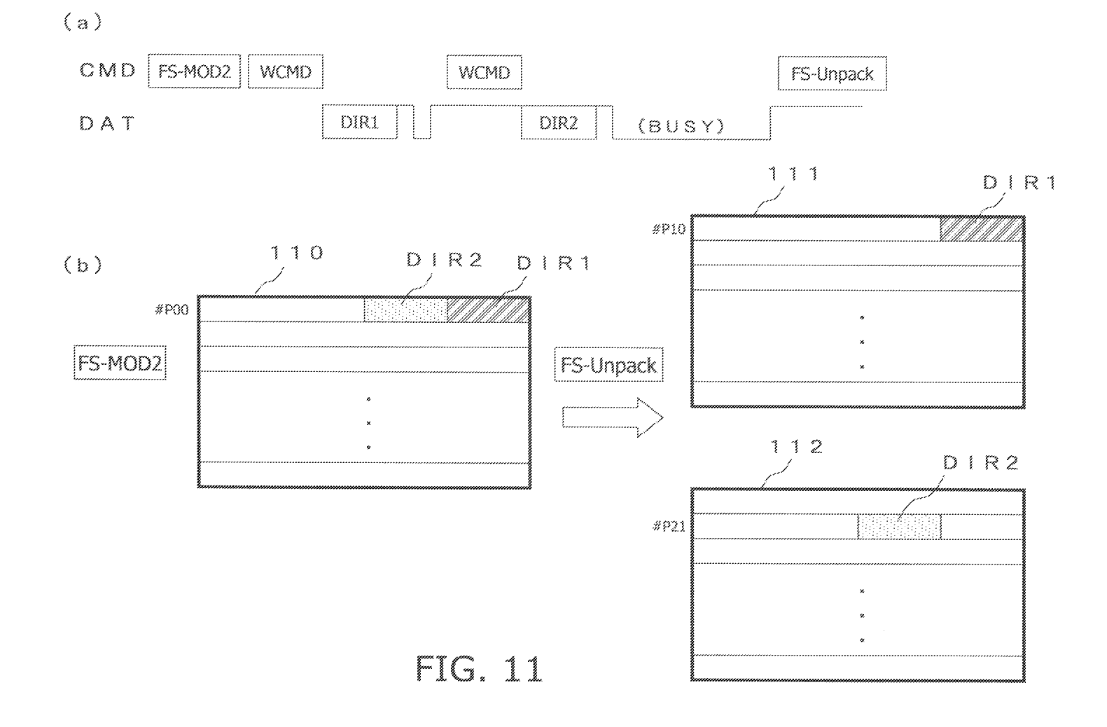

FIG. 11 is a diagram describing the processing performed in the nonvolatile memory system 1000 for relocating the file system information that has been written in the second file system information write mode in a manner that the information will be arranged in the same state as when it is written in the first file system information write mode.

FIG. 11(a) is a diagram describing command sequences associated with the relocation processing.

As shown in FIG. 11(a), the host device 2 generates a file system information write mode switching command FS-MOD2 and transmits the command to the memory device 1. After the memory device 1 writes file system information in the second file system information write mode, the host device 2 generates a file system information relocating command FS-Unpack and transmits the command to the memory device 1. In response to the command, the memory controller unit 11 included in the memory device 1 relocates data in the MAU that has been written in the second file system information write mode to a different MAU based on its logical address.

FIG. 11(b) schematically shows the processing performed in the nonvolatile memory system 1000 for relocating data in an MAU110 that has been written in the second file system information write mode to an MAU111 and an MAU112.

In FIG. 11(b), the MAU110 stores different file system information files, or specifically file system information DIR1 and file system information DIR2, in the same page (page #P00 in FIG. 11(b)). When the memory device 1 receives a file system information relocating command FS-Unpack, the memory controller unit 11 relocates the file system information stored in the MAU110 into the MAU111 and the MAU112 based on its logical addresses. More specifically, the memory controller unit 11 relocates the file system information DIR1 to the MAU111 and the file system information DIR2 to the MAU112. The address management unit 1122 included in the memory controller unit 11 manages the logical addresses of the file system information DIR1 and the file system information DIR2 using the RAM (not shown) included in the memory device 1 or using the nonvolatile memory 12.

In the nonvolatile memory system 1000 described above, the host device 2 generates a data relocating command D-Unpack or a file system information relocating command FS-Unpack at a selected timing, and then the memory device 1 relocates data or file system information in the MAU that has been written in the second data write mode or the second file system information write mode in accordance with the command. This enables the nonvolatile memory system 1000 to manage the data and the file system information in the same manner as when the data and the file system information are written in the first data write mode or the first file system information write mode.

The nonvolatile memory system 1000 may combine the relocation processing described above with other processing.

1.2.3.2 Relocation Processing (Combined with Other Processing)

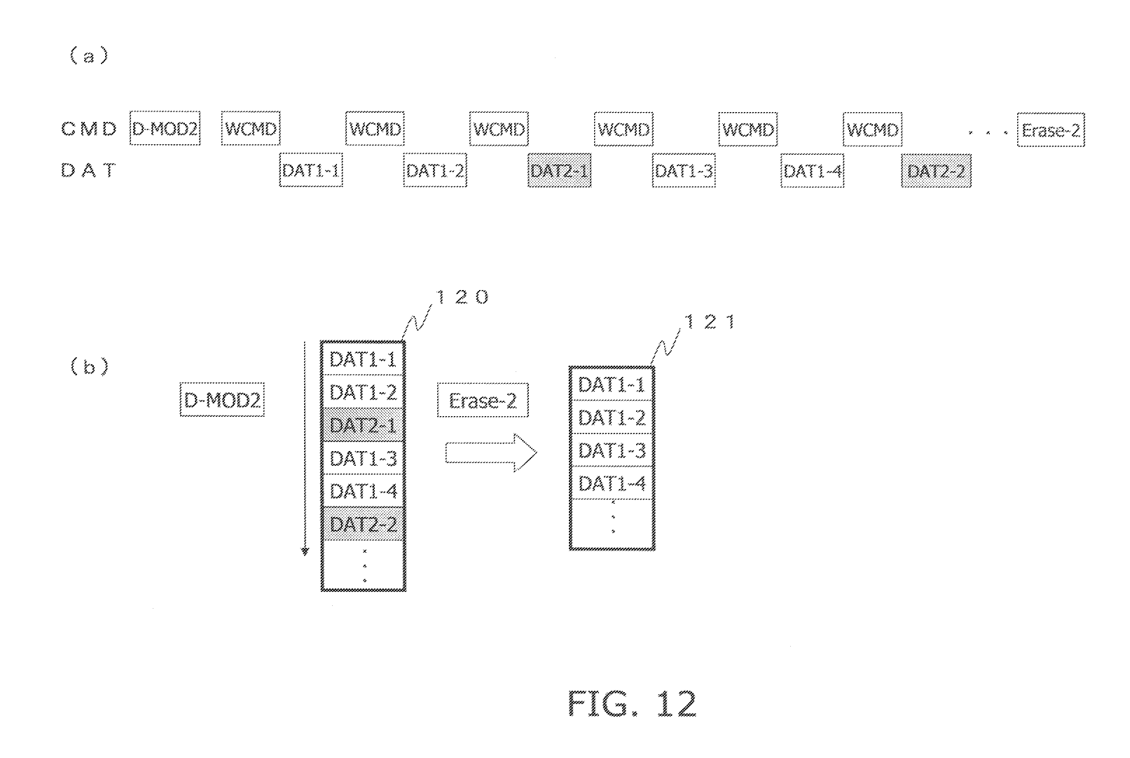

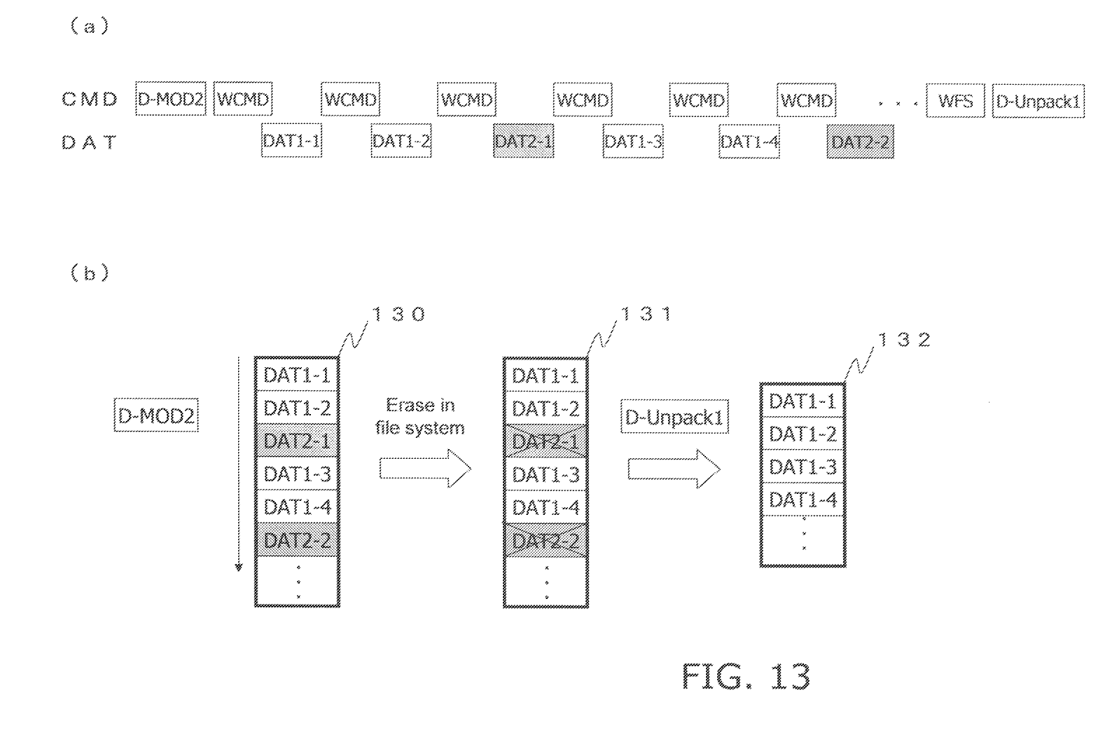

FIGS. 12 and 13 are diagrams describing examples of the transaction timings in the nonvolatile memory system 1000 when the relocation processing described above is combined with other processing.

When Combined with Data Erasure

The relocation processing combined with data erasure in the nonvolatile memory system 1000 will first be described.

FIG. 12 is a diagram describing the relocation processing combined with data erasure. FIG. 12 describes the processing for relocating data when the host device 2 generates and transmits an erasure command to the memory device 1.

A command Erase-2 shown in FIG. 12 causes the sequence shown in FIG. 14(c) or the sequence shown in FIG. 14(d). To simplify the drawings, details of the sequences caused by the command Erasure-2 and the like are not shown in FIG. 12.

FIG. 12(a) is a diagram showing command sequences associated with the relocation processing.

In FIG. 12(a), the host device 2 generates a data write mode switching command D-MOD2 and transmits the command to the memory device 1. The memory device 1 receives the data write mode switching command D-MOD2, and writes data in the second data write mode. Subsequently, in the nonvolatile memory system 1000, when one piece of data among a plurality of pieces of data is to be erased (data DAT2-m is to be erased in this example), the host device 2 generates an erasure command Erase-2 and transmits the command to the memory device 1. The memory device 1 receives the erasure command Erase-2, and erases the data DAT2-m, which is designated as erasure-target data by the erase command Erase-2, and further relocates the data DAT1-n.

FIG. 12(b) is a diagram describing the processing for relocating the data DAT1-n when the data DAT2-m is erased.

In FIG. 12(b), the MAU120 stores data DAT1-n (n=1, 2, . . . ) and data DAT2-m (m=1, 2, . . . ) belonging to two MAUs in the logical address space. When the memory device 1 receives, from the host device 2, a command Erase-2 for erasing the data DAT2-m among the two pieces of data stored in the MAU120, the memory controller unit 11 erases the data DAT2-m, and further relocates the data DAT1-n to the MAU121. The address management unit 1122 included in the memory controller unit 11 manages the data to be erased from the MAU120 and the data to be relocated from the MAU120 using the RAM (not shown) included in the memory device 1 or using the nonvolatile memory 12.

When Combined with Data Erasure Performed by File System Operation

The relocation processing combined with data erasure performed by the file system operation in the nonvolatile memory system 1000 will now be described.

FIG. 13 is a diagram describing the relocation processing combined with data erasure performed by the file system operation in the nonvolatile memory system 1000. More specifically, FIG. 13 describes the processing for relocating data when the host device 2 erases data recorded in the memory device 1 by the file system operation.

FIG. 13(a) is a diagram describing command sequences associated with the relocation processing.

In FIG. 13(a), the host device 2 generates a data write mode switching command D-MOD2 and transmits the command to the memory device 1. The memory device 1 receives the data write mode switching command D-MOD2, and writes data in the second data write mode. Subsequently, the host device 2 generates a write command WFS and transmits the command to the memory device 1. The memory device 1 receives the write command WFS, and updates the corresponding data in the file system (for example, the corresponding data in the file allocation table), and erases one piece of data, among a plurality of pieces of data that have been written (erases the data DAT2-m in this example) (erases the data by the file system operation). Subsequently, the host device 2 transmits a data relocation command D-Unpack1 for relocating the remaining data DAT1-m to the memory device 1. The memory device 1 receives the data relocation command D-Unpack1, and then performs the processing for relocating the data DAT1-m.

A command WFS shown in FIG. 13 causes the sequence shown in FIG. 14(b) or the sequence shown in FIG. 14(d). To simply the drawings, details of the sequences caused by the command WFS and the like are not shown in FIG. 13.

FIG. 13(b) is a diagram describing the processing for relocating the data DAT1-n after the data DAT2-m is erased by performing the file system operation in the nonvolatile memory system 1000.

In FIG. 13(b), the MAU130 stores data DAT1-n (n=1, 2, . . . ) and data DAT2-m (m=1, 2, . . . ) belonging to two MAUs in the logical address space. When the host device 2 erases the data DAT2-m by the file system operation, the state of the MAU130 changes to the state of the MAU131 in the file system as shown in FIG. 13(b). In FIG. 13(b), parts (pages) with cross marks are areas storing data in the nonvolatile memory 12 but from which data has been erased in the file system. When the host device 2 then generates a data relocation command D-Unpack 1 for relocating the data DAT1-n and transmits the command to the memory device 1, the memory controller unit 11 relocates the data DAT1-n, among a plurality of pieces of data stored in the MAU131, to the MAU132. In this case, the address management unit 1122 in the memory controller unit 11 manages the data to be erased and the data to be relocated among the plurality of pieces of data stored in the MAU131 using the RAM (not shown) included in the memory device 1 or the nonvolatile memory.

As described above, in the nonvolatile memory system 1000, the data erasure caused by the erasure command or the data erasure performed by the file system operation is performed when the host device 2 erases one of a plurality of files that have been recorded (data DAT1-n and data DAT1-m in the examples shown in FIGS. 12 and 13). In this manner, the relocation processing is performed at the same timing as when the data erasure caused by the erasure command or the data erasure performed by the file system operation in the nonvolatile memory system 1000 is performed. This enables the relocation processing to be performed efficiently. More specifically, the nonvolatile memory system 1000 performs the data relocation processing while the data erasure requiring a relatively long processing time is being performed. This enables the data relocation processing to be performed without causing the user to be aware that the data relocation processing is taking a long time.

As described above, when the host device 2 records a plurality of files of data or a plurality of files of file system information onto the memory device 1 in the nonvolatile memory system 1000 of the present embodiment, the host device 2 records the data or the file system information by switching the data write modes or the file system information write modes in a manner to shorten the period during which a Busy signal is being output from the memory device 1 to the host device 2. This shortens the period during which the host device 2 is in transmission wait state, and reduces the amount of data to be stored while the host device 2 is in transmission wait state.

As a result, the nonvolatile memory system 1000 enables real-time recording of a plurality of files to be performed easily without increasing the buffer size of the host device 2.

Further, the nonvolatile memory system 1000 enables the recorded data and the recorded file system information to be relocated without causing the user to be aware that the data relocation processing is being performed, and enables the data and the file system information to be arranged in the same state as when they are written in the first data write mode and the first file system information write mode. This eliminates the need for complicated data management of the nonvolatile memory 12 in the nonvolatile memory system 1000.

### Other Embodiments

Although the above embodiment describes the case in which two files are recorded in the nonvolatile memory system 1000, the present invention should not be limited to this structure. For example, three or more files may be recorded in the nonvolatile memory system 1000.

Further, the data write mode switching command, the file system information write mode switching command, the second data write mode end command, the second file system information write mode end command, the data relocation command, and the file system information relocation command may be separate commands having different identifiers, or may be formed using the same command having the same identifier. When these commands are formed using the same command having the same identifier, the argument setting is varied to enable the single command to function as the plurality of commands.

In the nonvolatile memory system, the data relocation and the file system information relocation may be performed separately using different commands, or the data relocation and the file system information relocation may be performed as the processing caused by a single command.

To enable the nonvolatile memory system to perform the data relocation and the file system information relocation easily, it is preferable to set, for example, the argument of each command to indicate the file number when the data and the file system information are written. The argument of each command setting the file number associates data and file system information for the same file. When, for example, data having a file number 1 and data having a file number 2 are to be recorded, the argument of each command may be set in the manner described below.

(1) The write command for writing data having the file number 1 is set to include an argument indicating the file number 1.

(2) The write command for writing file system information having the file number 1 is set to include an argument indicating the file number 1.

(3) The write command for writing data having the file number 2 is set to include an argument indicating the file number 2.

(4) The write command for writing file system information having the file number 2 is set to include an argument indicating the file number 2.

Alternatively, a command including information associating the file number and the MAU to which the file is written may be transmitted from the host device 2 to the memory device 1 before the data write mode or the file system information write mode is switched to the second data write mode or the second file system information write mode.

This is preferable because the transmission of such a command enables relocation-target data to be identified easily when the data relocation or the file system information relocation is performed in the nonvolatile memory system.

Although the above embodiment describes the case in which the nonvolatile memory 12 is formed by a flash memory, the present invention should not be limited to this structure. The nonvolatile memory system may be formed using another nonvolatile memory, such as a hard disk or a nonvolatile RAM.

Each block of the nonvolatile memory system, the host device, and the memory device described in the above embodiment may be formed using a single chip with a semiconductor device, such as LSI (large-scale integration), or some or all of the blocks of the nonvolatile memory system, the host device, and the memory device may be formed using a single chip.

Although LSI is used as the semiconductor device technology, the technology may be IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks. Biotechnology is potentially applicable.

The processes described in the above embodiment may be implemented using either hardware or software, or may be implemented using both software and hardware. When each of the nonvolatile memory system, the host device, and the memory device of the above embodiment is implemented by hardware, the nonvolatile memory system, the host device, and the memory device require timing adjustment for their processes. For ease of explanation, timing adjustment associated with various signals required in an actual hardware design is not described in detail in the above embodiment.

The specific structures described in the above embodiment are mere examples of the present invention, and may be changed and modified variously without departing from the scope and spirit of the invention.

### INDUSTRIAL APPLICABILITY

The memory device, the host device, and the memory system of the present invention enable real-time recording of a plurality of files to be performed while preventing the buffer size of the host device from increasing. In particular, the present invention is applicable to host devices such as television sets and digital video recorders (DVRs) that record moving images onto a large-capacity nonvolatile memory, and to memory devices such as removable memory cards or embedded devices using a nonvolatile memory.

1. A memory device that is connected to a host device to allow communication with the host device, and writes data and/or reads data in accordance with a command provided from the host device, the memory device comprising:
a nonvolatile memory storing data; and
a memory controller unit that controls writing of data to the nonvolatile memory and reading of data from the nonvolatile memory using a logical address included in the command provided from the host device, manages a memory area of the nonvolatile memory in memory allocation units, and controls data and file system information corresponding to the data to be written into different memory allocation units,
wherein the memory controller unit sets a data write mode by switching to a first data write mode or to a second data write mode as designated by the host device and controls writing of data to the nonvolatile memory to be performed in the set data write mode, and
(1) when writing data in the first data write mode, the memory controller unit associates a logical address of the host device with a physical address of the nonvolatile memory for each memory allocation unit, and selects a memory allocation unit into which the data is to be written in a physical address space of the nonvolatile memory using a logical address included in a data write command provided from the host device in a manner that a data arrangement in the memory allocation unit in a logical address space managed by the host device is identical to a data arrangement in the memory allocation unit in the physical address space of the nonvolatile memory, and writes the data into the selected memory allocation unit, and
(2) when writing data in the second data write mode, the memory controller unit selects a memory allocation unit into which the data is to be written in the physical address space of the nonvolatile memory as a memory allocation unit for the second data write mode, and continuously writes write-target data received from the host device in the selected memory allocation unit for the second data write mode irrespective of a logical address included in a data write command provided from the host device.

2. The memory device according to claim 1, wherein the memory controller unit writes data in the first data write mode in an initial state when the memory device is powered on or reset, and switches the data write mode to the second data write mode in accordance with a data write mode designating command provided from the host device.

3. The memory device according to claim 1, wherein
the memory controller unit switches the data write mode to the first data write mode in accordance with a data write mode designating command provided from the host device.

4. The memory device according to claim 1, wherein
the memory controller unit switches the data write mode to the first data write mode in accordance with a second data write mode end command provided from the host device.

5. The memory device according to claim 1, wherein
the memory controller unit relocates data that has been written in the second data write mode in the physical address space of the nonvolatile memory in a manner that a logical address of the data and a physical address of the data correspond to each other for each memory allocation unit in accordance with a data relocation command provided from the host device.

6. The memory device according to claim 1, wherein
when data that has been written in the second data write mode is partially erased in response to a data erasure command provided from the host device, the memory controller unit relocates the remaining data in the physical address space of the nonvolatile memory in a manner that the remaining data is arranged in a data arrangement identical to a data arrangement used in data writing performed in the first data write mode.

7. The memory device according to claim 1, wherein the memory controller unit sets a file system information write mode by switching to a first file system information write mode or to a second file system information write mode as designated by the host device and controls writing of file system information to the nonvolatile memory to be performed in the set file system information write mode, and
(1) when writing file system information in the first file system information write mode, the memory controller unit controls a plurality of different pieces of file system information that are designated to be written using different write commands provided from the host device to be written sequentially to the nonvolatile memory in response to each write command received from the host device, and
(2) when writing file system information in the second file system information write mode, the memory controller unit controls a plurality of different pieces of file system information that are designated to be written using different write commands provided from the host device to be written collectively into the same page of the nonvolatile memory.

8. The memory device according to claim 7, wherein the memory controller unit writes the file system information in the first file system information write mode in an initial state when the memory device is powered on or reset, and switches the file system information write mode to the second file system information write mode in accordance with a file system information write mode designating command provided from the host device.

9. The memory device according to claim 7, wherein
the memory controller unit switches the file system information write mode to the first file system information write mode in accordance with a file system information write mode switching command provided from the host device.

10. The memory device according to claim 7, wherein
the memory controller unit switches the file system information write mode to the first file system information write mode in accordance with a second file system information write mode end command provided from the host device.

11. The memory device according to claim 8, wherein
the memory controller unit relocates file system information that has been written in the second file system information write mode in the physical address space of the nonvolatile memory in a manner that the file system information is stored into a different physical page in accordance with a file system information relocation command provided from the host device.

12. A host device that writes data to a memory device and reads data from the memory device, the host device comprising:
a memory-device control unit that provides a command to the memory device and controls input and output of data to be written to the memory device or data to be read from the memory device, and manages a logical address space in memory allocation units and controls data and file system information corresponding to the data to be written in different memory allocation units,
wherein the memory-device control unit controls a data write mode of the memory device to switch to the first data write mode or to the second data write mode as designated by the memory-device control unit.

13. The host device according to claim 12, wherein
the memory-device control unit controls the memory device to operate in the first data write mode in an initial state when the memory device is powered on or reset, and subsequently provides a data write mode designating command to the memory device to switch the data write mode of the memory device to the second data write mode.

14. The host device according to claim 12, wherein
the memory-device control unit provides a data write mode designating command to the memory device to switch the data write mode of the memory device to the first data write mode.

15. The host device according to claim 12, wherein
the memory-device control unit provides a second data write mode end command to the memory device to switch the data write mode of the memory device to the first data write mode.

16. The host device according to claim 12, wherein
the memory-device control unit provides a data relocation command to cause the memory device to relocate data that has been written by the memory device in the second data write mode in the physical address space of the nonvolatile memory in a manner that the data is arranged in a data arrangement identical to a data arrangement used in data writing performed in the first data write mode.

17. The host device according to claim 16, wherein
when data that has been written to the memory device in the second data write mode is partially erased in a file system by updating file system information, the memory-device control unit controls the memory device to relocate data that has been written by the memory device in the second data write mode in the physical address space of the nonvolatile memory in a manner that the data is arranged in a data arrangement identical to a data arrangement used in data writing performed in the first data write mode.

18. The host device according to claim 12, wherein the memory-device control unit controls a file system information write mode of the memory device to switch to a first file system information write mode or to a second file system information write mode as designated by the memory-device control unit.

19. The host device according to claim 18, wherein the memory-device control unit controls the memory device to operate in the first file system information write mode in an initial state when the memory device is powered on or reset, and subsequently provides a file system information write mode designating command to the memory device to switch the file system information write mode of the memory device to the second file system information write mode.

20. The host device according to claim 18, wherein
the memory-device control unit provides a file system information write mode designating command to the memory device to switch the file system information write mode of the memory device to the first file system information write mode.

21. The host device according to claim 18, wherein
the memory-device control unit provides a second file system information write mode end command to the memory device to switch the file system information write mode of the memory device to the first file system information write mode.

22. The host device according to claim 18, wherein
the memory-device control unit provides a file system information relocation command to the memory device to cause the memory device to relocate data that has been written by the memory device in the second file system information write mode in the physical address space of the nonvolatile memory in a manner that the data is arranged in a data arrangement identical to a data arrangement used in data writing performed in the first file system information write mode.

23. A memory system, comprising:
the memory device according to claim 1; and
a host device that writes data to a memory device and reads data from the memory device, the host device comprising:
a memory-device control unit that provides a command to the memory device and controls input and output of data to be written to the memory device or data to be read from the memory device, and manages a logical address space in memory allocation units and controls data and file system information corresponding to the data to be written in different memory allocation units,
wherein the memory-device control unit controls a data write mode of the memory device to switch to the first data write mode or to the second data write mode as designated by the memory-device control unit.
